(19) United States
(12) Patent Application Publication
(10) Pub. No.: US 2013/0029858 A1
(43) Pub. Date: Jan. 31, 2013

(54) Method of Drug Screening through Quantitative Detection by Atomic Force Microscopy and Effective Protein Chips Development through Method Thereof

(71) Applicants: Hueih-Min Chen, Hsinchu (TW); Feng-Sheng Kao, Taichung (TW)

(72) Inventors: Hueih-Min Chen, Hsinchu (TW); Feng-Sheng Kao, Taichung (TW)

(73) Assignee: NATIONAL APPLIED RESEARCH LABORATORIES, Hsinchu (TW)

(21) Appl. No.: 13/192,118

(22) Filed: Jul. 27, 2011

(51) Int. Cl. C40B 30/04; C40B 50/18

(52) U.S. Cl. 506/9; 506/32

(57) ABSTRACT

A method for drug screening is provided. An atomic force microscopy (AFM) is used to obtain quantitative difference. At least one receptor is immobilized on a probe of the AFM and at least one ligand is immobilized on chips. By flowing a candidate drug on the chips or even applying different candidate drugs to different areas of each chip, drug screening is processed through measuring the binding force between the receptor and the ligand. Multiple drugs can be screened without weakening activity of the proteins during repeated drug screening processes. The drug screening process is cost saved and has high quality. Highly effective protein chips can be developed based on the present disclosure.

### TECHNICAL FIELD OF THE DISCLOSURE

The present disclosure relates to drug screening; more particularly, relates to immobilizing proteins on chips for drug screening with an external electric field applied to change homogeneous orientation of the proteins for improving effective use of the chips, where atomic force microscopy (AFM) is used to measure quantitative difference of binding force on at least one receptor of the proteins for drug screening.

### DESCRIPTION OF THE RELATED ARTS

Concerning immobilizing bio-molecules (particularly for proteins) on a chip, some issues are the keys, like activity, immobilization efficiency and immobilizing orientation. Immobilization of bio-molecules is widely used in biosensors and NDA/protein chips. By immobilizing a bio-molecule on a biosensor, the bio-molecule is detected for changes in physical characteristics. Those biosensors include sensors for surface plasmon resonance (SPR), quartz crystal microbalances (QCM) and surface acoustic wave (SAW), where the SPR sensor is the most well-known equipment used in life science.

Chen, H.-M, et al revealed a prior art concerning SPR technology in 2006 (Dong, G.-C., Chang, P.-H., Lin, Y.-C., Forrest, M. and *Chen, H.-M. (2006) “Immuno-suppressive effect of blocking CD28 signalling pathway in T-cell by an active component of Echinacea found by a novel pharmaceutical screening method” J. Med. Chem. 49, 1845-1854.; and Dong, G.-C., Chang, K-C., Jan, P.-S., Chuang, P.-H., Yi, M., Zhou, H.-X. and *Chen, H.-M. (2009) “Blocking effect of an immuno-suppressive agent, cynarin, on CD28 of T-cell”, Pharmaceutical Res. 26, 375-381.) By using an SPR equipment, difference between SPR signals is measured for drug screening when a drug is bond to a protein on a chip. This prior art ‘indirectly’ evaluates the drug by quantity; and, thus, the evaluation may not be accurate or significant.

M. F. Templin, et al revealed a prior art concerning fluorescence technology in 2002 (M. F. Templin, D. Stoll, M. Schrenk, P. C. Traub, C. F. Vöhringer and T. O. Joos, (2002) “Protein microarray technology” Trends in Biotechnology, 20, 160-166.) A protein marked with a fluorescent material is bond with other proteins immobilized on a chip. Through a quantitative detection of fluorescence, strength of fluorescence is measured to screen out target materials. Although this prior art is fast, the strength of fluorescence will be wakened as time flies and accuracy is thus weakened. In addition, fluorescent material may cause unspecific bonds, like physical adhesion, and cause error result.

Generally speaking, performance for immobilizing proteins on chip may be affected by the following factors: stability, homogeneity and orientation. Therein, self-assembled monolayer (SAM) can be used to solve the problems on stability and homogeneity, where covalent binding is used to immobilize single layer of protein on chip. But the problem on orientation still remains. Although SAM can solve the problems on stability and homogeneity, downward-oriented antigens (or ligands), for example, are still hard to be bond with the proteins if active bonding sites of the proteins on the chip are mostly buried underneath. As a result, the performance of the chip is greatly reduced.

Traditionally, physical characteristics like light, frequency and surface plasma are used for bio-sensing. But, problems on stability, homogeneity and orientation are not fully solved. Hence, the prior arts do not fulfill all users' requests on actual use.

### SUMMARY OF THE DISCLOSURE

The main purpose of the present disclosure is to provide a drug screening method by immobilizing cell membrane receptors on chips to be detected for quantitative difference by an AFM.

The second purpose of the present disclosure is to block a binding force between two bio-molecules with a small molecule of a drug and using the AFM to measure the binding force for obtaining a target drug.

The third purpose of the present disclosure is to use two electrodes (an electric field) to change orientation of proteins of the receptors on the chips for improving effective use of the chips.

The fourth purpose of the present disclosure is to provide an accurate and effective method for screening candidate drugs quantitatively and repeatedly.

To achieve the above purposes, the present disclosure is a method of drug screening through quantitative detection by AFM and effective protein chip development through the method thereof, comprising steps of: (a) immobilizing at least one receptor on a surface of each one of a plurality of chips and immobilizing at least one ligand to the receptor on a surface of a probe of an AFM; (b) flowing a drug through the chips to bind the drug to the receptor; and (c) processing point-to-point detection with the AFM to obtain binding forces between the receptor and the ligand and to further obtain blocking effect by the drug. Accordingly, a novel method of drug screening through quantitative detection by AFM and effective protein chip development through the method thereof is obtained.

### BRIEF DESCRIPTIONS OF THE DRAWINGS

The present disclosure will be better understood from the following detailed description of the preferred embodiment according to the present disclosure, taken in conjunction with the accompanying drawings, in which

FIG. 1 is the flow view showing the preferred embodiment according to the present disclosure;

FIG. 2 is the view showing the first state-of-use;

FIG. 3A and FIG. 3B are the views showing the binding forces between the receptor and the ligand before and after blocking by the drug;

FIG. 4A is the view showing the distribution of the binding force;

FIG. 4B is the view showing the distribution after the bond between the receptor and the ligand is blocked;

FIG. 5 is the view showing the second state-of-use;

FIG. 6A is the view showing the distribution of the binding force between imm-rIgG and afm-Protein A without the external electric field applied;

FIG. 6B is the view showing the distribution of the binding force between imm-rIgG and afm-Protein A with the positive electric field applied; and

FIG. 6C is the view showing the distribution of the binding force between imm-rIgG and afm-Protein A with the negative electric field applied.

### DESCRIPTION OF THE PREFERRED EMBODIMENT

The following description of the preferred embodiment is provided to understand the features and the structures of the present disclosure.

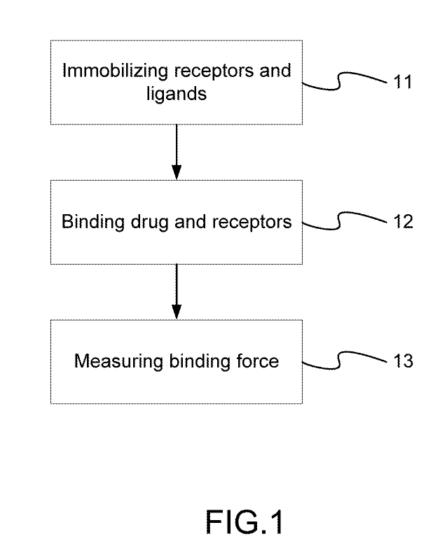

Please refer to FIG. 1 to FIG. 4B, which are a flow view showing a preferred embodiment according to the present disclosure; a view showing a first state-of-use; views showing binding forces between a receptor and a ligand before and after blocking by a drug; a view showing a distribution of the binding force; and a view showing the distribution after the bond between the receptor and the ligand is blocked. As shown in the figures, the present disclosure is a method of drug screening through quantitative detection by atomic force microscopy (AFM) and effective protein chip development through the method thereof, where a protein having disease-related cell membrane receptor is immobilized on chips applied with electrodes to process quantitative difference detection with an AFM for drug screening. The method of drug screening comprises the following steps:

(a) Immobilizing receptor and ligand [11]: At least one receptor is immobilized on a surface of each one of a plurality of chips [2] and at least one ligand to the receptor is immobilized on a surface of a probe [3] of an AFM. Therein, the chip [2] can be extended to a micro-array chip immobilized with different kinds of receptors.

(b) Binding drug to receptor [12]: A drug [4] is flowed through the chip [2] to bind the drug [4] to the receptor.

(c) Measuring binding force [13]: The AFM is used to processing point-to-point detection for acquiring blocking effect by the drug [4] according to the binding forces between the receptor and the ligand. If the binding force between the drug [4] and the receptor is bigger than the binding force between the receptor and the ligand, the drug [4] is identified as capable of breaking the bond between the receptor and the ligand, vice versa.

In step (a), an external electric field is applied to change an orientation of the receptor on each chip, where the external electric field is 1 mV to 5V and two electrode substrates are separated for 0.1 mm to 1.0 mm.

In step (c), the drug [4] is a herbal medicine extract, a small molecule, a microbe extract, or a cellular extract, etc. After the drug [4] is removed (e.g. by washing) from the chips [2] immobilized with the receptor, the chips [2] can be reused for screening other drugs.

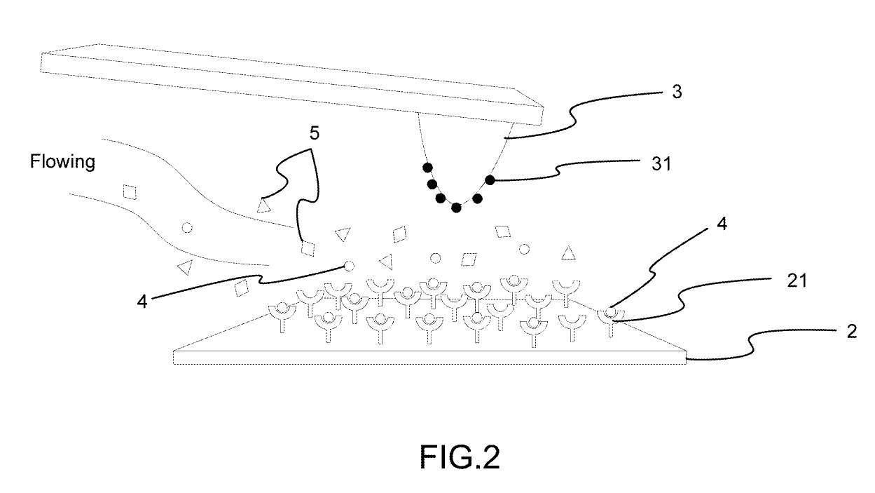

Take immuno-suppressive agent as an example. In FIG. 2, a receptor of T-cell membrane, CD28, is immobilized on chips [2], which is a protein labeled as imm-CD28 [21]. A ligand to CD28, ligand-CD80, is immobilized on a probe [3] of an AFM, which is a receptor on immune B-cell membrane and is labeled as afm-CD80 [31]. Since the binding between CD80 and CD28 is related to human anaphylactic reaction, a small-molecule drug [4] can be applied to block the binding between CD28 and CD80 for reducing immuno-reaction and anaphylactic reaction if the binding force between the drug [4] and CD28 is bigger than that between CD80 and CD28. By measuring the binding force between CD28 and CD80 to see whether the CD28/CD80 binding force is greatly reduced after applying the drug [4] on CD28, the drug [4] is identified as effective or not on blocking the binding between CD28 and CD80.

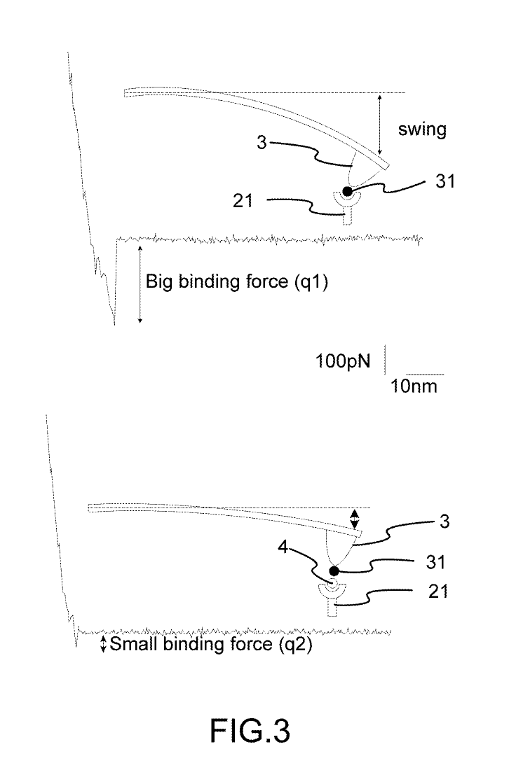

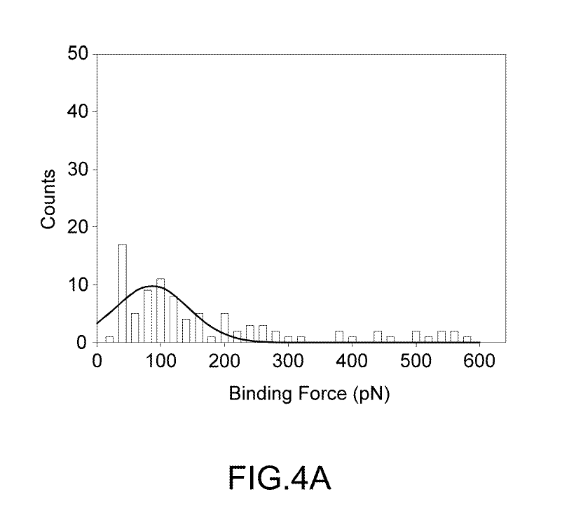

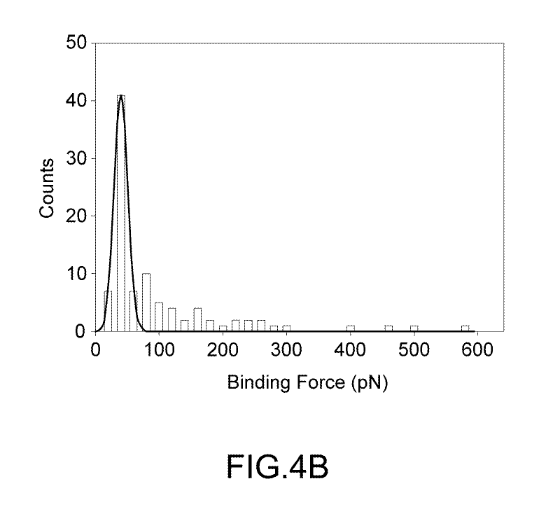

Take an immuno-suppressive drug candidate [4], cynarin, as an example. The imm-CD28 [21] is immobilized on the chips [2] and the afm-CD80 [31] is immobilized on the probe [3]. Then the drug candidate [4], cynarin, is flowed through the chips [2] to be bond with imm-CD28 [21] and separated from other components [5]. In FIG. 3, a binding force (q1) between CD28 and CD80 on afm-CD80 [31] is great before adding cynarin. After adding the effective immuno-suppressive drug candidate 3, cynarin, the bond between CD28 and CD80 is blocked to form a very small binding force (q2). That is, q1>>q2. In each Gaussian distribution curve shown in FIG. 4A and FIG. 4B, values obtained from 100 positions on each chip are used to figure out an average value for the chip. Therein, before adding cynarin, the average binding force between CD28 and CD80 is shown in FIG. 4A, which is about 167 pN±14 (q1). After adding cynarin, the average binding force is reduced to about 90 pN±11 (q2), as shown in FIG. 4B. The difference between the binding forces before and after adding cynarin is about 77 pN (q1−q2=167 pN−90 pN) or 46%. Thus, the present disclosure is able to screen drugs effectively and significantly.

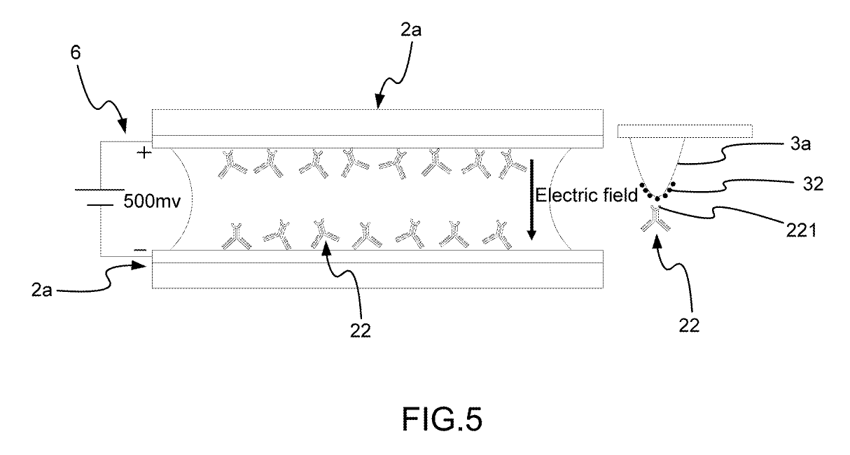

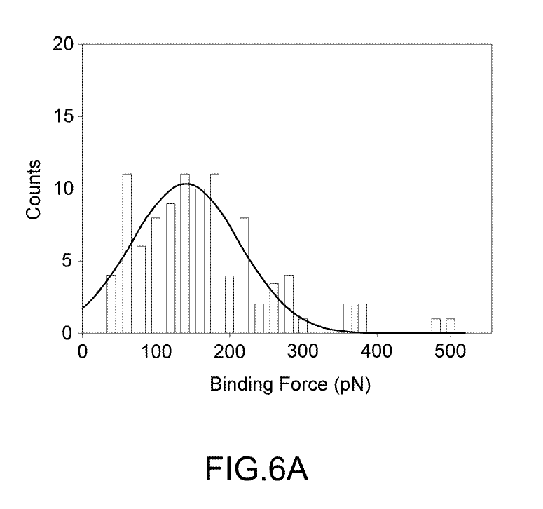

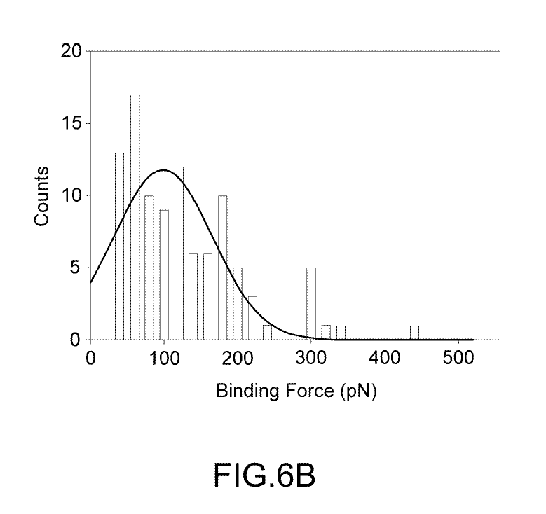

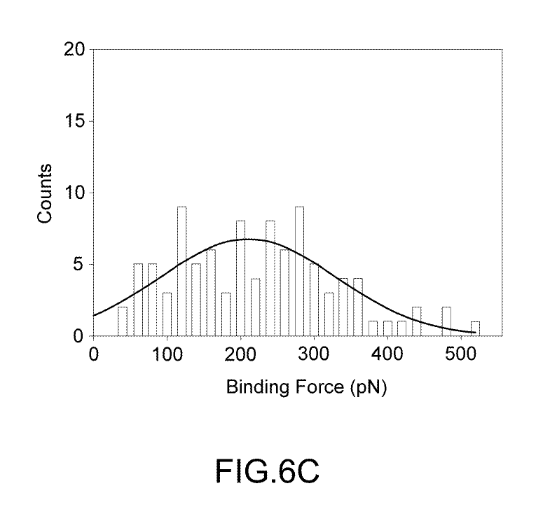

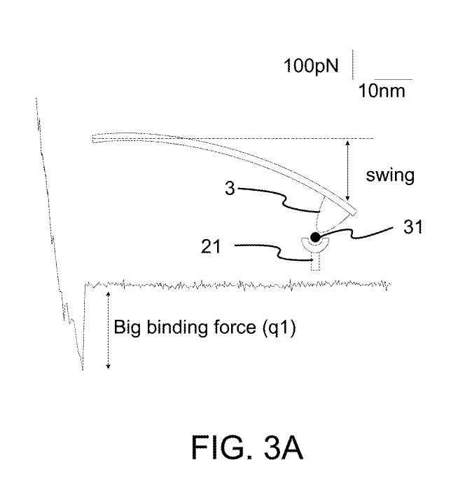

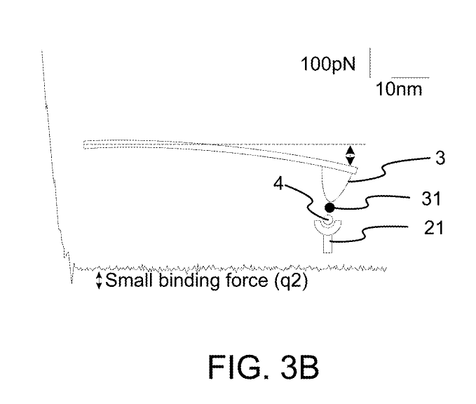

Please refer to FIG. 5 to FIG. 6C, which are a view showing a second state-of-use; a view showing a distribution of a binding force between imm-rIgG and afm-Protein A without the external electric field applied; a view showing a distribution of a binding force between imm-rIgG and afm-Protein A with the positive electric field applied; and a view showing a distribution of the binding force between imm-rIgG and afm-Protein A with the negative electric field applied. As shown in the figures, the present disclosure uses an external electric field to change orientation of proteins on each chip to expose external reactors of the proteins for improving performance of the chips.

In FIG. 5, a protein A, which is labeled as afm-Protein A [32], is immobilized on a probe [3a] of an AFM; and an antibody protein of rIgG (rabbit IgG), which is an antibody protein to the protein A and is labeled as imm-rIgG [22], is immobilized on two chips [2a] and the two chips are connected with two electrodes [6]. Therein, the protein A is a special protein on surface of staphylococcus aureus, which has a molecular weight about 43 kDa and can be bond with an Fc terminal [221] of a general rIgG. In FIG. 6A to FIG. 6C, 100 positions on each chip [2a] are measured for their binding forces to figure out Gaussian distribution curves; and, the optimum concentration for imm-rIgG is between 5 μgml⁻¹ and 10 μgml⁻¹. As shown in FIG. 6A, when external electric field is not applied, average binding force between afm-Protein A and imm-rIgG is 154 pN±19; but, as shown in FIG. 6B, when external electric field is applied, the average binding force between afm-Protein A and imm-rIgG becomes 118 pN±16. The binding force is reduced for about 23%. However, when negative electric field of −500 mV is applied, the average binding force between afm-Protein A and imm-rIgG is 213 pN±25, which becomes bigger for about 38%.

Conclusively saying, the external electric field changes the orientation of rIgG immobilized on the chips [2a]. When a positive external electric field generated by the electrodes is applied, the binding force becomes smaller than that without the positive external electric field applied. It is because that the Fc terminals [221], which can be bond with rIgG, of the protein A immobilized on the chips [2a], are less exploded out (re-oriented to face down) by the external electric field. Yet, when a negative external electric field is applied, the condition is exactly reversed: the Fc terminals [221] are re-oriented with face up to increase the binding force. Thus, the present disclosure uses electrodes as substrates to form an external electric field for increasing related reaction extent to a protein by changing orientation of the protein and for thus further improving effective use of the chips.

The strength of the above electric field is 1 mV to 5V. When the strength is lower than 1 mV, the reaction efficiency is not changed as compared to that without electric field applied. When the strength is higher than 5V, unexpected reactions, like side effects of chemical electric reaction and bubbling, will happen. Besides, two electrode substrates are separated for 0.1 mm to 1.0 mm. When the distance is shorter than 0.1 mm, abnormal situation will happen. When the distance is longer than 1.0 mm, the reaction rate is as low as that without electric field applied.

Hence, the present disclosure uses AFM to precisely measure bonding force between proteins for screening drugs. Take receptors of CD28 (T-cell) and CD80 (B-cell) on immune cell membrane as an example. These receptors are proteins to be bond for immuno-reaction. A drug of cynarin is used to block the bond between the two immune proteins. The AFM is used to measure quantitative difference on binding force between the two immune proteins before and after applying the drug. An external electric field can be further applied to change homogeneous orientation of the proteins immobilized on the chips for improving effective use of the chips. The present disclosure is operated dot by dot on each chip, so that activity of the proteins is not weakened after many times of measuring in multiple operations. If micro-array technology is applied with different drugs added to different areas, cost for screening drug can be further reduced.

The present disclosure thus has the following characteristics:

(1) The present disclosure does not use light, frequency or surface plasma for bio-sensing. With an AFM, drug screening is done by measuring binding force on the protein immobilized on each chip after small molecules of a drug are applied to block the binding force of bio-molecules of the protein. Electrodes (electric field) are further used to change orientation of the protein for improving effective use of the chips.

(2) Regarding drug screening, the AFM can be used to detect a very small area and to detect different areas for many times. Even more, micro-array technology can be used to immobilize different proteins on each of the same chips for screening different candidate drugs. Further, electrodes of the chips can be used as substrates to form an external electric field to change orientation of protein for improving effective use of the chips.

(3) The present disclosure improves accuracy and effectiveness of the chips. The drug screening done through the present disclosure is quantitative and repeatable. Hence, more accurate and effective candidate drugs can be screened out for developing therapy drug with develop time saved and develop success increased.

(4) The present disclosure can be applied to all related protein targets for quantitative measurement of drug screening and for effectively immobilizing protein on chip with electrodes.

To sum up, the present disclosure is a method of drug screening through quantitative detection by AFM and effective protein chip development through the method thereof, where a first protein is immobilized on a probe of an AFM to measure a binding force between the first protein and a second protein immobilized on chips; the binding force can be measured for many times with activity of the proteins remained; micro-array technology can be used to apply different drugs on different areas of each chip for fast and cost-effective drug screening; and, thus, the present disclosure helps fabricating effective protein chips with reduced cost and enhanced quality.

The preferred embodiment herein disclosed is not intended to unnecessarily limit the scope of the disclosure. Therefore, simple modifications or variations belonging to the equivalent of the scope of the claims and the instructions disclosed herein for a patent are all within the scope of the present disclosure.

What is claimed is:

1. A method of drug screening through quantitative detection by atomic force microscopy (AFM), comprising steps of:
(a) obtaining at least one receptor on a surface of each one of a plurality of chips and obtaining at least one ligand to said receptor on a surface of a probe of an AFM, wherein said chips is connected with at least two electrodes to obtain an external electric field to change said receptor into an homogeneous orientation;
(b) flowing a drug through said chips to bind said drug to said receptor; and
(c) processing point-to-point detection with said AFM to obtain a binding force between said receptor on said chips and said ligand on said probe of said AFM and to further obtain blocking effect by said drug.

2. The method according to claim 1,
wherein said chip is extended to a micro-array chip immobilized with different receptors.

3. The method according to claim 1,
wherein, in step (a), said external electric field is 1 mV to 5V and two of said substrates are separated for 0.1mm to 1.0 mm.

4. The method according to claim 3,
wherein said homogeneous orientation of said receptor is an upward orientation to expose said receptor.

5. The method according to claim 1,
wherein, in step (c), said drug is identified to be able to block a bond between said receptor and said ligand when said binding force between said drug and said receptor are bigger than said binding force between said receptor and said ligand.

6. The method according to claim 1,
wherein said drug is a material selected from a group consisting of a herbal medicine extract, a small molecule, a microbe extract and a cellular extract.

7. The method according to claim 1,
wherein, after said drug is separated from said receptor immobilized on said chips, a new drug is flowed through said chips to be screened.

8. A method of effectively immobilizing proteins on chips applied with electrodes, comprising steps of:
(a) immobilizing a first protein on a probe of an AFM;
(b) immobilizing a second protein on at least two chips and connecting said chips with at least two electrodes as two substrates;
(c) obtaining an external field with said two electrodes to change orientation of said second protein on said chip to enhance effective use of said chips.

9. The method according to claim 8,
wherein said first protein has an optimum concentration between 5 μgml⁻¹ and 10 μgml⁻¹.

10. The method according to claim 8,
wherein said second protein is an antibody protein to said first protein.

11. The method according to claim 8,
wherein said chip is a micro-array chip immobilized with different receptors.

12. The method according to claim 8,
wherein said external electric field is 1 mV to 5V and two of said substrates are separated for 0.1 mm to 1.0 mm.
